(19) United States
(12) Patent Application Publication
(10) Pub. No.: US 2006/0080316 A1
(43) Pub. Date: Apr. 13, 2006

(54) Multiple indexing of an electronic document to selectively permit access to the content and metadata thereof

(75) Inventors: Alan Ross Gilmore, Holywood (GB); Graham Lee, Belfast (GB); Brian Gerard Philip McErlean, Coleraine (GB); Fergus Martin Wilson, Saintfield (GB); Gary Turnbull, Belfast (GB)

Correspondence Address: TESTA, HURWITZ & THIBEAULT, LLP, HIGH STREET TOWER, 125 HIGH STREET, BOSTON, MA, 02110, US

(73) Assignee: Meridio Ltd, Belfast (GB)

(21) Appl. No.: 10/961,415

(22) Filed: Oct. 8, 2004

(51) Int. Cl. G06F 17/30

(52) U.S. Cl. 707/9

(57) ABSTRACT

The disclosed technology enhances the granularity of access control systems by indexing electronic documents of interest in a manner that selectively provides authorized users with access to either content or metadata of such documents. Restriction indicia corresponding to, for example, a full-access permission and a limited-access permission, are assigned to an electronic document and this restriction indicia is compared with a user's authorization level to determine whether the user should be granted full access to the electronic document's content or be granted a limited access restricted to the document's metadata.

### TECHNICAL FIELD

The disclosed technology relates generally to restricting access to electronic documents, and more particularly to indexing an electronic document multiple times to selectively permit access to and/or manipulation of desired information subsets of that document.

### BACKGROUND

Electronic documents, such as textual data, e-mail messages, audio segments, video segments, electronic records, and other digital representations of information, have traditionally been protected from unauthorized access by restricting physical access to a digital data processing device containing such documents and/or requiring that users submit credentials for authentication prior to approving access to electronic documents of interest. A user's credentials are normally compared with a security identifier and/or any other number and type of elements in a pre-established access control list that associates a particular user or user group with a permission (e.g., read access, write access, deny access, etc.).

Although access control lists have effectively restricted access to sensitive documents in networked environments within a particular organization or domain, the widespread dissemination of electronic documents across the world wide web and other wide area networks or metropolitan area networks has complicated not only the management and integration of such access control lists but also the types of access that are to be granted to particular users. For example, users from different organizations that are collaborating on a particular project may desire access to each other's electronic documents and the access control lists and associated processes and access privileges may be incompatible and prove difficult to harmonize.

Access control lists incorporated into more structured environments, such as collaboration portals, can restrict access to the portal and provide a basic level of security, but may not provide the degree of access granularity desired by collaborating participants to specific electronic documents of interest. For example, authorized users of a portal may desire that their counterparts have a more limited type of read access to certain sensitive documents or parts thereof, but may not want to entirely disable or block access to the documents or hide their existence. Accordingly, individuals, organizations, associations and other types of entities interested in controlling access to electronic documents have a continuing interest in developing more flexible access control technologies that provide a greater degree of access granularity.

### SUMMARY

The disclosed technology enhances the granularity of access control systems by indexing electronic documents of interest in a manner that selectively provides authorized users with access to either full-access objects (e.g., the entirety of an electronic document's information, such as in some embodiments, its content and metadata) or limited-access objects (e.g., information subsets that are not as inclusive as the aggregate information of full-access objects, such as metadata) of such documents. Restriction indicia corresponding to, for example, a full-access permission and a limited-access permission, are assigned to an electronic document and this restriction indicia is compared with a user's authorization level to determine whether the user should be granted full access to the electronic document's content or be granted a limited access that is restricted to the document's metadata.

In one illustrative embodiment, the disclosed technology is used to develop systems and perform methods in which one or more electronic documents are searched based on search criteria, where such search criteria are based on the content information and/or metadata of the electronic document. Access to the content information of the electronic document matching the search criteria can be selectively permitted based on a user's authorization level. The sufficiency of the user's authorization level can be based on indicia within the metadata of the matching electronic document and/or on a location of such document. The selective permission for a particular type of access can involve, without limitation, comparing the user's authorization level to restriction indicia that were previously assigned to the electronic document matching the search criteria. In one embodiment, if a user's authorization level is determined to be compatible with the restriction indicia, then access to the content information of the matching electronic document is permitted, whereas, if the user's authorization level is incompatible with the restriction indicia, access to the content information is prevented but access to the matching electronic document's metadata may be permitted.

In one illustrative embodiment, the disclosed technology is used to develop systems and perform methods in which access to one or more electronic documents are restricted. In such an embodiment, an authorization level associated with a received access request for a particular restricted-access document can be compared with restriction indicia associated with the restricted-access document, where such restriction indicia correspond to, for example, a full-access permission and/or a limited-access permission. The authorization level associated with the received access request may be indicative of a user's access privileges that are determined based on credentials supplied during a login process. In response to a comparison of an authorization level and restriction indicia, an access request can be processed to provide access to data associated with a restricted-access document such that access is provided to the content of the restricted-access document upon the authorization level being compatible with a full-access permission or access is limited to the metadata associated with the restricted-access document upon the authorization level being incompatible with the full-access permission, but compatible with a limited-access permission.

In this embodiment, an electronic document (which may be in conformity with a predetermined document template) and its full-access and/or limited-access permissions can be received and restriction indicia can be assigned to such electronic document to form a restricted-access document prior to the receipt of an access request. The access request for the restricted-access document can be conveyed in response to a selection of one or more search terms in a selectable list, where such search terms are identified within the metadata and/or content of the restricted-access document. The search terms of the selectable list can be associated with location information corresponding to the restricted-access document.

The content and/or metadata of a restricted-access document can be stored in one or more directory folders within a cache or other volatile or nonvolatile memory of a digital data processing device and restriction indicia associated with the restricted-access document can be further associated with the directory folders storing the document. The content and/or metadata of the restricted-access document can be incorporated into the content of a web page that is transmitted to a digital data processing device participating in a collaboration session, in which an access request for the restricted-access document was transmitted by such digital data processing device the collaboration session. Prior to receiving an access request, storage location information (e.g., a cache location, a hard drive location, and/or a database location of the restricted-access document) can be inserted into the metadata of the restricted-access document to facilitate the retrieval of at least part of the restricted-access document. The metadata can also identify a version of the restricted-access document and/or include the restriction indicia associated with the restricted-access document.

In one illustrative embodiment, the disclosed technology can be used to develop systems and perform methods of restricting access to an electronic document in which an electronic document having metadata and content information associated therewith is further associated with a first and/or second permission level. The first permission level authorizes access to the content information of the electronic document to users associated with a first authorization level. The second permission level restricts access to the content information, but authorizes access to the metadata of the electronic document to users associated with a second authorization level. The first and/or second permission levels can be stored within the metadata of the electronic document and/or can be based on a directory folder containing the electronic document. At least a part of the electronic document can also be received in conformity with a predetermined document template.

A selectable list of search terms can be formed to include one or more search terms identified with the metadata and/or content information of a particular electronic document. Upon detecting a selection of at least one of the search terms in the document's metadata or content information by a user with a second authorization level, a displayable representation of the metadata can be formed for such user. Similarly and upon detecting a selection of at least one of the search terms in the document's metadata or content information by a user with a first authorization level, a displayable representation of the content information and/or the metadata of the electronic document can be formed for such user. The metadata of the electronic document can also identify a version of the document and/or include stored location information that facilitates retrieval of the document.

In one illustrative embodiment, the disclosed technology can be used to develop systems and perform methods for selectively accessing information subsets (e.g., one or more limited-access objects) of an electronic document. A number of access permission types can be determined and assigned to at least some of an electronic document's information subsets and such access permission types can correspond to varying degrees of access to the electronic document. At least some of the electronic document's information subsets can be repetitively indexed to facilitate their subsequent access and/or manipulation by entities with compatible access permissions. The number or index repetitions applied to one or more of the document's information subsets can be based on the number of access permission types assigned to such subsets.

### BRIEF DESCRIPTION OF THE DRAWINGS

The foregoing discussion will be understood more readily from the following detailed description of the disclosed technology, when taken in conjunction with the accompanying drawings in which:

FIG. 1 schematically illustrates an exemplary architecture for indexing an electronic document multiple times to selectively permit access to that document's content and/or metadata, in accordance with an illustrative embodiment of the disclosed technology;

FIG. 2 illustrates an exemplary methodology for performing multiple indexing operations on an electronic document;

FIG. 3 illustrates an exemplary methodology used in searching and accessing electronic documents of interest that have been indexed using the methodology of FIG. 2; and

FIG. 4 schematically illustrates a web-based implementation of the exemplary architecture of FIG. 1.

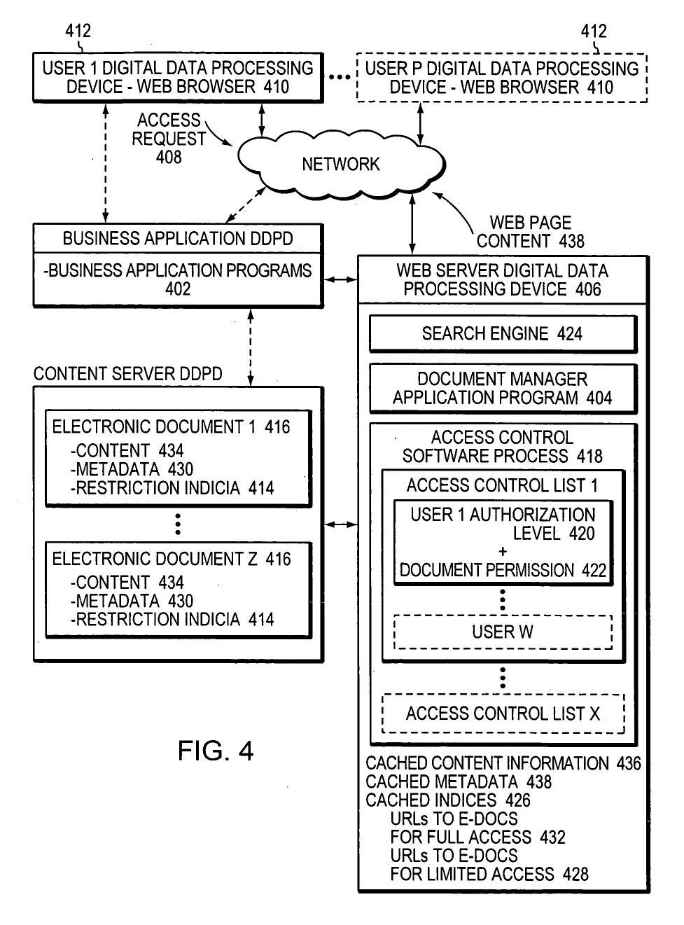

### DETAILED DESCRIPTION

Unless otherwise specified, the illustrated embodiments can be understood as providing exemplary features of varying detail of certain embodiments, and therefore, unless otherwise specified, features, components, modules, elements, constructs, processes, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

For the purposes of this disclosure, the term “substantially” can be broadly construed to indicate a precise relationship, condition, arrangement, orientation, and/or other characteristic, as well as, deviations thereof as understood by one of ordinary skill in the art, to the extent that such deviations do not materially affect the disclosed methods and systems.

For the purposes of this disclosure, the term “process” can be broadly construed to refer to the execution of instructions that interact with operating parameters, message data/parameters, network connection parameters/data, variables, constants, software libraries, and/or any other elements needed for the proper execution of the instructions, within an execution environment in a memory of a digital data processing device, that causes a processor to control the operations of the data processing device in accordance with the desired functionality of an operating system, software application program, and/or any other type of generic or specific-purpose application program (or subparts thereof). Those skilled in the art will recognize that the various processes discussed herein are merely exemplary of the functionality performed by the disclosed technology and thus such processes and/or their equivalents may be implemented in commercial embodiments in various combinations and quantities without materially affecting the operation of the disclosed technology.

For the purposes of this disclosure, a digital data processing device can be construed broadly to refer to a personal computer, computer workstation (e.g., Sun, HP), laptop computer, server computer, mainframe computer, handheld device (e.g., personal digital assistant, Pocket PC, cellular telephone, etc.), information appliance, or any other type of generic or special-purpose, processor-controlled device capable of receiving, processing, and/or transmitting digital data. A processor refers to the logic circuitry that responds to and processes instructions that drive digital data processing devices and can include, without limitation, a central processing unit, an arithmetic logic unit, an application specific integrated circuit, a task engine, and/or any combinations, arrangements, or multiples thereof.

For the purposes of this disclosure, a data communications network can refer to a series of network nodes that can be interconnected by network devices and communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the originating and destination network nodes.

In brief overview, the disclosed technology can be incorporated into document management systems that enable users at various authorization levels to store, maintain, and/or access documents and records in a flexible manner. An electronic document, such as textual data, e-mail messages, audio segments, video segments, electronic records, and/or combinations thereof or other types of digital representations of data or information, under the control of a document management system includes one or more “full-access” objects and/or one or more “partial or limited-access” objects. Full-access objects refer to data or information that may be viewed or otherwise accessed by users with an unrestricted authorization level (i.e., those that have full access) and may include, for example, the entirety of an electronic document's information. By way of non-limiting example and with respect to some illustrative embodiments, a full-access object can refer to an electronic document's content (e.g., the text of this disclosure that is normally viewable within a word processing program) as well as the document's properties (referred to herein as metadata). Limited-access objects refer to data or information that may be viewed or otherwise accessed by users with less than full access and may, for example, include one or more information subsets that are associated with an electronic document and that are not as inclusive as the aggregate information of full-access objects. By way of non-limiting example and with respect to some illustrative embodiments, limited-access objects can be restricted to a document's metadata.

Metadata can include fixed properties, which may be determined by a document management or other type of system, and custom properties that may be defined by authorized users and/or administrators to more particularly tailor an electronic document for a particular organization and/or use. Metadata can be assigned, not only to electronic documents, but also to containers (e.g., directory folders or equivalents thereto that contain one or more electronic documents or pointers/references/indices to such documents) and other logic/organizational constructs and such metadata or parts thereof can be inherited or shared amongst multiple such electronic documents and containers and/or can serve as a basis for distinguishing between particular electronic documents and particular containers. Accordingly, an electronic document's metadata can serve as an index that uniquely identifies the document and/or relates the document to particular groups of similar or related documents. For example, searching one or more data structures (e.g., databases, tables, lists, etc.) containing an electronic document and/or its metadata for particular metadata field values (e.g., date document created, user identifier for the creator of the document) may identify more than one electronic document created on a particular day by a particular user, whereas more unique metadata fields (e.g., unique document identification code) or a larger quantity of metadata fields may focus the search results on a specific electronic document. Metadata can also be applied to containers that include or reference electronic documents, stored searches, and/or other containers.

By way of non-limiting example, an electronic document's metadata can include one or more of the following, separately or in any combination: indicia pertaining to a user who added, viewed, modified, or otherwise manipulated the document in a document management system; indicia pertaining to the document's author; an indicator identifying whether the document inherits the access control parameters of a container including or pointing to the document; indicia associated with a document's category or classification; user-added comments; date and time indicia for when the document was created, edited, or otherwise manipulated; unique document identifier and/or other document identification indicia; identifiers pertaining to the status (e.g., locked or unlocked, checked-in or checked-out, etc.) or maintenance (e.g., marked for deletion) of the document; version of the document; storage policy (e.g., archive after 30 days); storage location and directory path of the metadata and/or the storage location and directory path of corresponding content information; and/or any other type of information or indicia useful or desirable for the storage, maintenance, or access of electronic documents. A wide variety of similar or dissimilar metadata fields can also be associated with containers or other types of logic/organizational constructs within a document management system to facilitate the operation of such system.

Retrieving information about full-access objects (including, for example, an electronic document's content and metadata) or limited-access objects (e.g., an electronic document's metadata) from a document management system may require that an operator (e.g., user, administrator, etc.) of the system present credentials (e.g., user ID and password) to the system to authenticate his identity as a particular authorized user or as a member of a particular authorized user group (e.g., system administrator group, end user group, resource disposition group, electronic document management group, etc.) and thereby be associated with a pre-assigned authorization level (e.g., add, delete, modify, or view electronic documents) and be granted certain permissions (e.g., no access, read-only access, write access, unrestricted/full access, etc.) to access and/or otherwise manipulate electronic documents, containers, stored searches, and/or other types of resources or parts thereof controlled or managed by the system. Such authorization levels and permissions can be stored in one or more access control lists and can also form part of (or be referenced by) an object's metadata.

Access and/or manipulation of individual electronic documents, containers, and/or other types of digital representations or organizational constructs can be further secured by assignment of restriction indicia thereto. The term “restriction indicia” can be construed broadly to refer to indicators or markings (e.g., a word or phrase from, preferably, a predefined list) that further restrict a user's access to a particular electronic document, container, etc. By way of non-limiting example, restriction indicia can include one or more of the following, separately or in substantially any combination: a phrase that identifies a common attribute of users (e.g., U.S. EYES ONLY, STRATEGIC MARKETING ONLY, EMPLOYEE BENEFIT COMMITTEE ONLY, etc.); a code word (e.g., a password for a particular document); a classification descriptor (e.g., appointments, budget, commercial, contracts, or the like); indicia of an organization or association (e.g., Meridio Ltd., NATO, WIPO, American Cancer Society, or the like); a security category (e.g., top secret, secret, confidential, restricted, etc.); restrictions inherited by higher level containers and/or any other type of indicator that uniquely pertains to an electronic document, container, etc. For the purposes of this disclosure, an electronic document containing or otherwise being associated with restriction indicia is referred to herein as a restricted-access document.

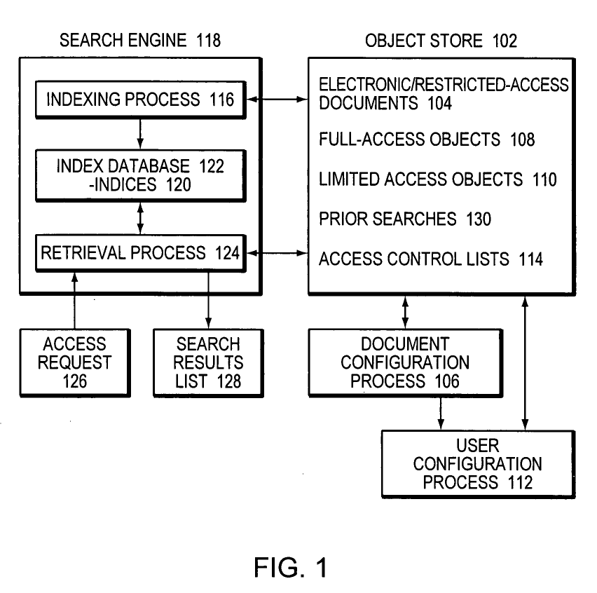

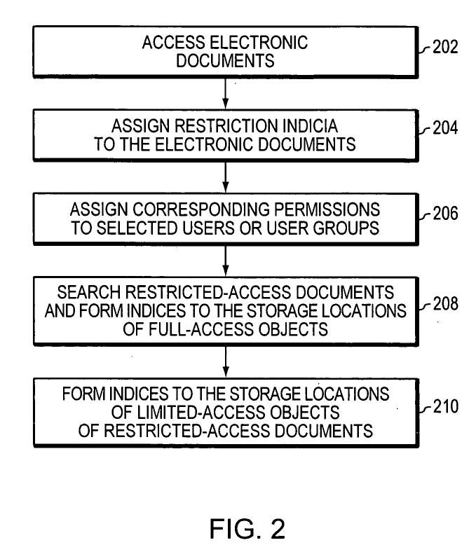

In one illustrative embodiment and with reference to FIGS. 1 and 2, an administrator or other authorized user of a document management system forms new electronic documents or accesses existing electronic documents from a repository 102 of such documents 104 (202). The new or existing electronic documents 104 are, preferably, in a form that is in accordance with a predetermined document template, such as in XML format with tags assigned to particular metadata field values. If the electronic documents 104 do not presently include restriction indicia or other access permissions, but such indicia is desired, the administrator or other authorized user of the document management system can execute a document configuration process 106 that provides a user interface (e.g., with drop-down list boxes identifying possible selections for restriction indicia) to facilitate the assignment of desired restriction indicia to each electronic document 104 and thereby form restricted-access documents 104 corresponding to full-access objects 108 and/or limited-access objects 110 (204). The document configuration process 106 can also inform a user configuration process 112 of the permissions required for authorized users or user groups to access the restricted-access documents 104 and/or to identify such users or groups, which enables the user configuration process 112 to incorporate such information into one or more access control lists 114 (206). Although the embodiment shown in FIG. 1 shows the access control lists 114 residing in the object store 102, those skilled in the art will recognize that the storage location of such access control lists 114 are merely exemplary and that they can be stored in a variety of other locations, so long as they are communicatively coupled to a document management system incorporating aspects of the disclosed technology.

Once the restricted-access documents 104 have been properly configured with restriction indicia, the document management system can periodically (or upon the occurrence of an event) execute an indexing process 116 of a search engine 118 that traverses the object store 102 and forms indices 120 (e.g., URLs) that identify the storage locations of full-access objects 108 (e.g., a document's content and metadata) associated with the restricted-access documents 104 (208). The indices 120 can include references to containers or other types of organizational constructs that either store the electronic documents 104 therein or include other indices that point to the storage location of the documents 104 or to other constructs in the directory path of the document 104. The indices 120 and/or containers can be stored in one or more index databases 122 for subsequent access by a retrieval process 124 as further described below. The document management system can also perform other types of processes (e.g., encryption, decryption, compression, decompression, etc.) substantially prior to, coincident with, or following an indexing operation and such additional processes can pertain to particular data or information elements that may or may not be associated with a restricted-access document 104 subjected to the indexing process.

The restricted-access documents 104 can be re-indexed by the indexing process 116 substantially any number of times to, for example, index metadata changes, storage location changes, and/or other types of modifications to the restricted-access documents and/or to further index unmodified documents for different types of access and/or for substantially any other purpose. For example, after a restricted-access document 104 has been indexed with respect to full-access objects 108 (e.g., the document's content and metadata), the document 104 can be resubmitted to the indexing process 116 so that indices 120 to the storage locations of corresponding limited-access objects 110 (e.g., the document's metadata) can be formed (210). In this manner, the indices 120 stored in the index database 122 include URLs or other types of references that uniquely identify the location of one or more full or limited-access objects 108, 110 (e.g., content and metadata) based on the restriction indicia assigned to such objects and this facilitates retrieval of the objects during subsequent searches by users with various permission and authorization levels.

The number of indexing passes or operations to which a restricted-access document is subjected can be based on a variety of factors, such as on a number and type of selective access mechanisms (e.g., authorization levels, document permissions, etc.) that may be desired by particular users of a document management system. The number of such indexing passes can also be static (e.g., based on a predetermined number of passes set by a user or administrator) or dynamic (e.g., based on parameters determined during the execution of one or more processes and/or based upon the occurrence of an event).

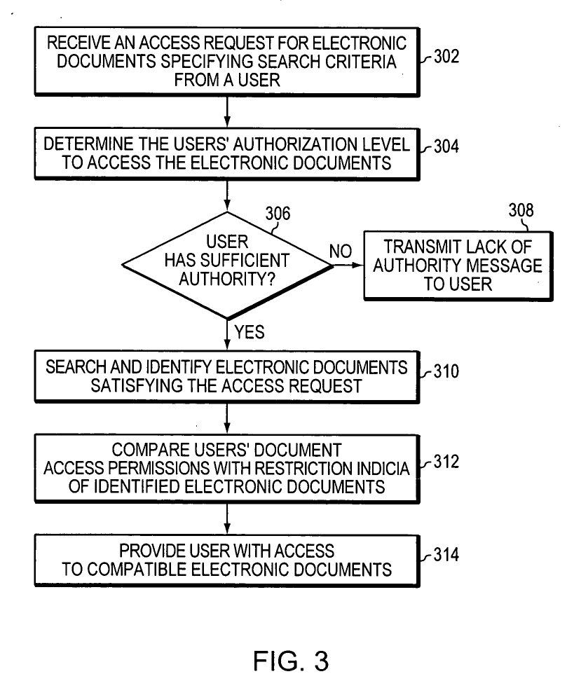

With reference now to FIGS. 1 and 3, a document management system incorporating at least some aspects of the disclosed technology can receive an access request 126 from a user or user-controlled process or system that specifies search criteria, which are to be used in a search to identify electronic documents of interest (302). The access request 126 can include indicia pertaining to the user's authorization level and/or access permissions along with the search criteria, alternatively, such authorization level and/or access permissions can be first ascertained by an authentication process (not shown) that retrieves such information from one or more access control lists 114 (304). A determination can then be made by a retrieval process 124 of a search engine 118 or by the authentication process as to whether the user has sufficient authority to view and/or otherwise access electronic documents of interest (306). If the user's authorization level is insufficient to enable a user to make the access request submitted, then a message can be transmitted to the user indicative of such insufficiency (308). Otherwise and assuming that a user has a sufficient authorization level, a retrieval process 124 can search one or more index databases 122 for indices 120 that identify the locations to and/or restriction indicia of full or limited-access objects 108, 110 of restricted-access documents 104 that fulfill the search criteria specified in the access request 126 (310).

The restriction indicia associated with the restricted-access documents 104 that fulfill the search criteria and which identify the set of users or user groups authorized to access full and/or limited-access objects 108, 110 of such documents 104 can be compared with user identification information for the user that submitted the access request 126 (312). Particular ones of the restricted-access documents whose restriction indicia specify the requesting user are deemed compatible with the user and thus the appropriate full or limited-access objects thereof can be provided to the user or otherwise be made available to the user (314). In one embodiment, the location of an index within a particular container is indicative of a corresponding document's restriction indicia. In another embodiment, a document's metadata (which may also be stored within or communicatively coupled to the index database 122) can include the document's restriction indicia. The document management system can also store prior successful/compatible searches 130 by properly authorized users within the object store 102 to facilitate future searches on the same or similar subject matter.

In one illustrative embodiment, a business application program 402, such as a program enabling a web-based collaboration of multiple users, can rely on a document manager application program 404 executing on a digital data processing device operating as a web server 406 to service access requests 408 submitted by web browser application programs 410 executing on one or more digital data processing devices 412 under the control of users participating in a collaboration session in a manner that preserves the access restrictions 414 associated with electronic documents 416 targeted by such access requests 408. Although the document manager application program 404 is shown and described as executing on the web server 406, those skilled in the art will recognize that all or part of the application program 404 may be executed on different digital data processing devices (e.g., a user interface portion of the document manager application program 404 may be executing on a web server, while data manipulation extensions of such program 404 may be executing on a content server that stores and maintains a repository of electronic documents 416).

An access request 408 specifying a particular electronic document 416 or requesting all electronic documents 416 that meet particular search criteria can be received by a document manager application program 404, which subsequently instructs an access control software process 418 (authentication process) to ascertain a corresponding user's authorization level 420 and/or other access permissions 422 that are necessary to access such requested documents 416. Assuming that a user has a sufficient authorization level to issue an access request 408 and/or to view or otherwise manipulate electronic documents 416 of the type requested, the document manager application program 404 can instruct a search engine 424 to search for indices 426 (which may be stored within a cache of the web server 406) that correspond to electronic documents of interest. If the search engine ascertains that the requesting user is authorized to access an electronic document of interest (by, for example, confirming that such user is listed among the set of authorized users specified in the document's restriction indicia), then the search engine can return a search result list (displayable within web page content 428 transmitted from the web server 406 to the associated web browser 410) that contains indices 426 to such desired and compatible electronic documents or parts thereof (e.g., full-access objects and/or limited-access objects).

If a user is found to be authorized for limited access to the electronic documents of interest, then the returned indices in the search result list will include URLs 428 to limited-access objects (e.g., metadata 430) of electronic documents 416. However, if a user is found to be authorized for full access to the electronic documents of interest, then the returned indices in the search results list will include URLs 432 to full-access objects (e.g., content information 434 and metadata 430) of such documents. In one embodiment, the frequency with which certain content information 436 and/or metadata 438 appears in search result lists, may warrant that such information be cached on the web server 406 to improve retrieval performance.

Although the disclosed technology has been described with reference to specific embodiments, it is not intended that such details should be regarded as limitations upon the scope of the invention.

What is claimed is:

1. A method of searching a plurality of electronic documents using search criteria, each electronic document having content information and metadata, the method comprising:
searching the plurality of electronic documents based on the search criteria, the search criteria being based on at least one of the content information and metadata; and
based on a user's authorization level, selectively permitting access to the content information of an electronic document matching the search criteria.

2. The method of claim 1, further comprising:
determining a sufficiency of the user's authorization level based on indicia within the metadata of the matching electronic document.

3. The method of claim 1, further comprising:
determining a sufficiency of the user's authorization level based on a location of the matching electronic document.

4. The method of claim 1, wherein selectively permitting access to the content information comprises:
comparing the user's authorization level to restriction indicia previously-assigned to the matching electronic document, wherein
upon the user's authorization level being compatible with the restriction indicia, permitting access to the content information of the matching electronic document, and
upon the user's authorization level being incompatible with the restriction indicia, preventing access to the content information and permitting access to the metadata of the matching electronic document.

5. A method of restricting access to an electronic document, the method comprising:
receiving a request to access a restricted-access document;
determining an authorization level associated with the request;
comparing the authorization level to restriction indicia associated with the restricted-access document, the restriction indicia corresponding to one of a full-access permission and a limited-access permission; and
in response to the comparison, processing the request to provide access to data associated with the restricted-access document, the processing of such request including:
upon the authorization level being compatible with the full-access permission, providing access to a content of the restricted-access document, and
upon the authorization level being incompatible with the full-access permission and compatible with the limited-access permission, limiting access to metadata associated with the restricted-access document.

6. The method of claim 5, further comprising:
prior to receiving the access request,
receiving an electronic document;
receiving the full-access permission and limited-access permission for the electronic document; and
assigning restriction indicia to the electronic document to form the restricted-access document.

7. The method of claim 6, wherein at least a part of the electronic document is received in conformity with a predetermined document template.

8. The method of claim 6, further comprising:
identifying search terms within the metadata and content of the restricted-access document;
forming a selectable list of search terms including at least one of the identified search terms; and
conveying the access request for the restricted-access document in response to a selection of the at least one identified search term in the selectable list.

9. The method of claim 8, further comprising:
associating the search terms of the selectable list with location information of corresponding restricted-access document.

10. The method of claim 5, further comprising:
storing at least one of the content and metadata of the restricted-access document in at least one directory folder within a cache of a digital data processing device.

11. The method of claim 10, wherein the restriction indicia associated with the restricted-access document is further associated with the at least one directory folder storing such document.

12. The method of claim 5, further comprising:
incorporating at least one of the content and metadata of the restricted-access document within a web page content; and
transmitting the web page content to a digital data processing device participating in a collaboration session, wherein the access request was transmitted by such digital data processing device during the collaboration session.

13. The method of claim 5, further comprising:
prior to receiving the access request,
inserting storage location information into the metadata of the restricted-access document, the storage location information facilitating retrieval of at least part of the restricted-access document.

14. The method of claim 13, wherein the storage location information includes at least one of a cache location, a hard drive location, and a database location of the restricted-access document.

15. The method of claim 5, wherein the metadata identifies a version of the restricted-access document.

16. The method of claim 5, wherein the restriction indicia associated with the restricted-access document is included within the metadata.

17. The method of claim 5, wherein the authorization level associated with the request is indicative of a user's access privileges, the user's access privileges being determined based on credentials supplied during a login process.

18. A method of restricting access to an electronic document, the method comprising:
accessing an electronic document having metadata and content information associated therewith;
associating a first permission level with the electronic document, the first permission level authorizing access to the content information of the electronic document to users associated with a first authorization level;
associating a second permission level with the electronic document, the second permission level restricting access to the content information but authorizing access to the metadata of the electronic document to users associated with a second authorization level.

19. The method of claim 18, wherein at least a part of the electronic document is received in conformity with a predetermined document template.

20. The method of claim 18, wherein the first and second permission levels associated with the electronic document are stored within the metadata of such document.

21. The method of claim 18, wherein the first and second permission levels associated with the electronic document are based on a directory folder containing such document.

22. The method of claim 18, further comprising:
identifying search terms within the metadata and content information;
forming a selectable list of search terms including at least one of the identified search terms; and
upon detecting a selection of the at least one identified search term in the selectable list by a user having a second authorization level, forming a displayable representation of the metadata for such user.

23. The method of claim 18, further comprising:
identifying search terms within the metadata and content information;
forming a selectable list of search terms including at least one of the identified search terms; and
upon detecting a selection of the at least one identified search term in the selectable list by a user having a first authorization level, forming a displayable representation of the content information and metadata of the electronic document for such user.

24. The method of claim 18, further comprising:
storing location information in the metadata of the electronic document to facilitate retrieval of such document.

25. The method of claim 18, wherein the metadata of the electronic document identifies a version of such document.
